(19) United States
(12) Patent Application Publication
(10) Pub. No.: US 2016/0265569 A1
(43) Pub. Date: Sep. 15, 2016

(54) STRUCTURES AND METHODS FOR RELEASABLE ENGAGEMENT OF SURFACES

(71) Applicant: Elwha LLC, Bellevue, WA (US)

(72) Inventors: W. Daniel Hillis, Encino, CA (US); Jordin T. Kare, San Jose, CA (US); Lowell L. Wood, JR., Bellevue, WA (US)

(73) Assignee: ELWHA LLC, Bellevue, WA (US)

(21) Appl. No.: 14/657,591

(22) Filed: Mar. 13, 2015

(51) Int. Cl. F16B 5/08; F16B 5/06

(52) U.S. Cl. CPC F16B 5/08; F16B 5/0621; F16B 5/0664

(57) ABSTRACT

Systems, methods, and apparatuses discloses herein relate to an object that includes an engagement surface defining a recess extending into the object and a movable member received within the recess. The movable member is movable between a first range of positions and a second range of positions, wherein in the first range of positions the movable member is at or below the engagement surface, and wherein in the second range of positions at least a part of the movable member is above the engagement surface.

### BACKGROUND

Many assembly processes in manufacturing, machining, robotics, and the like involve joining objects which must be precisely aligned. Such alignment is often provided by mating surfaces having complementary features, such as pins and holes, bumps and hollows, or tabs and slots, which, when engaged, prevent the mating surfaces from translating (sliding) relative to each other. In some cases, these feature also interlock, holding the two surfaces together, either temporarily or permanently. However, such alignment or interlocking features are not identical, i.e., a feature on one surface must engage with a complementary feature on the other surface, not an identical feature. This requires that the surface features be predetermined, and prevents, for example, having three surfaces, any two of which can be placed together and interlock. In many applications it would be desirable to be able to mate surfaces with alignment or interlocking features that can be identical on both surfaces.

### SUMMARY

One embodiment relates to an object. The object includes an engagement surface defining a recess extending into the object and a movable member received within the recess. The movable member is movable between a first range of positions and a second range of positions, wherein in the first range of positions the movable member is at or below the engagement surface, and wherein in the second range of positions at least a part of the movable member is above the engagement surface.

Another embodiment relates to an object. The object includes a bottom surface, a top surface positioned opposite the bottom surface, wherein the top surface defines a recess extending between the top surface and the bottom surface, and a rotatable member received within the recess. The rotatable member is rotatable between a first range of positions and a second range of positions, wherein in the first range of positions the rotatable member is at or below the top surface, and wherein in the second range of positions at least a part of the rotatable member is above the top surface.

Still another embodiment relates to an object. The object includes an engagement surface defining a recess and a groove. The object also includes a rotatable member sized to fit within the recess, wherein the rotatable member includes a protrusion structured to be received in the groove. The protrusion and the groove define a range of rotation of the rotatable member.

Yet another embodiment relates to an object. The object includes an engagement surface defining a recess extending into the object, and a translatable member received within the recess. The translatable member is translatable between a first range of positions and a second range of positions, wherein in the first range of positions the translatable member is at or below the engagement surface, and wherein in the second range of positions at least a part of the translatable member is above the engagement surface.

Still another embodiment relates to a system. The system includes a first object defining a first plurality of recesses and a first plurality of rotatable members, wherein each rotatable member of the first plurality of rotatable members is received in a recess of the first plurality of recesses. The system also includes a second object engageable with the first object, the second object defining a second plurality of recesses and a second plurality of rotatable members, wherein each rotatable member of the second plurality of rotatable members is received in a recess of the second plurality of recesses. According to one embodiment, a first rotatable member of the first plurality of rotatable members is at least partly received in a first recess of the second plurality of recesses. According to another embodiment, a first rotatable member of the second plurality of rotatable members is at least partly received in a first recess of the first plurality of recesses to substantially prevent translation of the first and second objects in at least one translational direction.

Another embodiment relates to a system. The system includes a first object defining a first plurality of recesses and a first plurality of movable members, wherein each movable member of the first plurality of movable members is received in a recess of the first plurality of recesses. The system also includes a second object engageable with the first object, the second object defining a second plurality of recesses and a second plurality of movable members, wherein each movable member of the second plurality of movable members is received in a recess of the second plurality of recesses. According to one embodiment, at least one movable member of the first plurality of rotatable members mates with at least one movable member of the second plurality of movable members to engage the first object to the second object and substantially prevent translation of the first and second objects relative to each other in at least one translational direction According to another embodiment, the distribution of and type of movable member (e.g., rotatable or translatable) distributed may be at random or in a periodic arrangement on each substrate. In some embodiments, the distribution may be specific to each object to be engaged. The distribution may control compatibility between two or more objects (i.e., whether they may or may not be engaged).

One embodiment relates to a method for engaging two or more objects. The method includes moving first and second objects into adjacent positions; sliding at least one of the first and second objects relative to the other to align a movable member of the first object with a recess of the second object; aligning a movable member of the second object with a recess of the first object; actuating the movable member of the first object to be at least partly received in the recess of the second object; and actuating the movable member of the second object to be at least partly received in the recess of the first object to put the first object and second object in an engaged position.

Still a further embodiment relates to a method for engaging two or more objects. The method includes moving first and second objects into adjacent positions; sliding at least one of the first and second objects relative to the other to align a first rotatable member of the first object with a first recess of the second object; aligning a first rotatable member of the second object with a first recess of the first object; rotating the first rotatable member of the first object in a first rotational plane at least partly into the first recess of the second object; and rotating the first rotatable member of the second object in a second rotational plane different from the first rotational plane into the first recess of the first object to substantially prevent two degrees of translational freedom of the first object relative to the second object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a diagram of a system of engaged objects, according to one embodiment.

FIG. 1B is a cutout view of the system of FIG. 1A, according to one embodiment.

FIG. 2A is a side cross-sectional view of the system of FIGS. 1A-1B, according to one embodiment.

FIG. 2B is a top perspective view of the second object of FIGS. 1A-2A with the rotatable members removed, according to one embodiment.

FIG. 3 is a schematic diagram of engaging a first object to a second object via rotatable members, according to one embodiment.

FIG. 4 is a schematic diagram of rotatable members used to engage objects using an actuation mechanism, according to one embodiment.

FIG. 5 is a schematic diagram of engaged first and second objects, according to one embodiment.

FIG. 6 is a schematic diagram of a rotation constraining mechanism for rotatable members used to engage objects, according to one embodiment.

FIGS. 7A-7D are schematic diagrams of rotatable members for engaging objects, according to various embodiments.

FIG. 8 is a schematic diagram of an attachment mechanism for a rotatable member to an object, according to one embodiment.

FIGS. 9A-9C are schematic diagrams of an attachment and rotation constraining device for a rotatable member, according to one embodiment.

FIGS. 10A-10B are schematic diagrams of a translatable member used to engage two or more objects, according to one embodiment.

FIG. 11 is a control system for selectively engaging and disengaging objects, according to one embodiment.

FIG. 12 is an actuator for engaging/disengaging objects usable with the control system of FIG. 11, according to one embodiment.

FIG. 13 is a depiction of mating surfaces for movable members, according to one embodiment.

FIG. 14 is a schematic diagram of a placement of and type of movable members for an object, according to one embodiment.

FIGS. 15A-15B are flowcharts of methods of engaging two or more objects, according to one embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the Figures generally, various embodiments disclosed herein relate to the structure and functionality of surfaces for engagement (also referred to herein as engaging objects). According to the present disclosure, an object includes a bottom surface and a top surface defining at least one recess (e.g., a groove). The object also includes at least one movable member sized to fit within each recess and movable between a first range of positions and a second range of positions. In the first range of positions, the movable member rests at or below the top surface. In the second range of positions, the movable member protrudes above the top surface. According to one embodiment, the movable member is structured as a rotatable member (e.g., shaped as a half-cylinder, half-sphere, half-toroid, etc.). In other embodiments, the movable member is structured as a translatable member. To engage two objects, a movable member of the first object is aligned with a recess of the second object and a movable member of the second object is aligned with a recess of the first object. Each of the movable members are then moved into the second range of positions, such that each of the movable members are protruding at least partly into each corresponding recess. Due to this engagement, the first and second objects are substantially prevented from sliding relative to each other. Movable members of the first and second objects that are unaligned with recesses of the first and second objects, respectively, situate in the first range of positions so to avoid adversely impacting the engagement of the two objects. To disengage the objects, the protruding movable members are moved into the first range of positions and the objects are slidably disengaged from each other. Accordingly, the objects may be selectively engaged and disengaged. In turn, the objects may be recycled and re-purposed for various applications. These and other features of the systems and methods of the present disclosure are described more fully herein.

While generally described above as “objects,” the objects and engaging surfaces of the present disclosure have a wide range of applications from micro- to macro-scale. In one embodiment, the objects may be used in robotics. For example, with the use of actuators or actuating mechanisms (described below), the objects may be used to create a self-assembling structure. In other embodiments, the objects may be structured as substrates that are used in electronics (e.g., to form or create printed circuit boards, semi-conductor manufacturing, integrated circuits, etc.). The objects of the present disclosure may also be utilized with micro-electromechanical systems (e.g., sensors, biomedical devices, displays, etc.). The objects of the present disclosure may further be utilized with macro-scale applications. For example, the engaged surfaces may be utilized to form a locking device for a safe or other lockable enclosure. Thus, while the objects are described generally herein, it should be understood that the use of such engaging surfaces is widely applicable, with all such applications intended to fall within the spirit and scope of the present disclosure. Due to this wide applicability, the objects described herein may be constructed from a variety of materials, such as magnetic materials (e.g., ferrous alloys, etc.), non-magnetic materials (e.g., plastics, etc.), and a combination thereof.

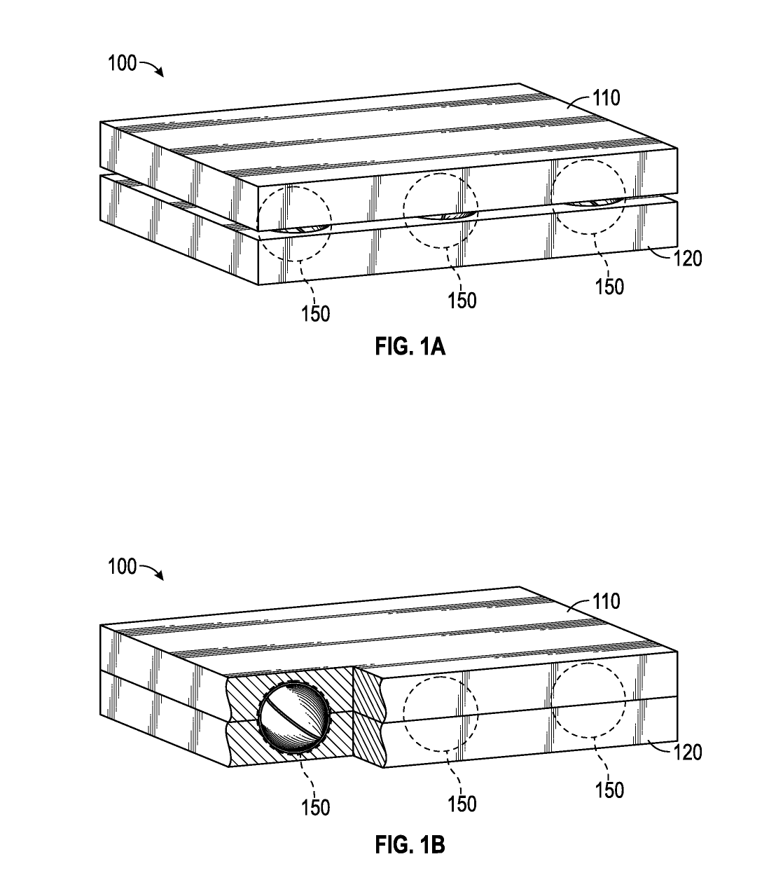

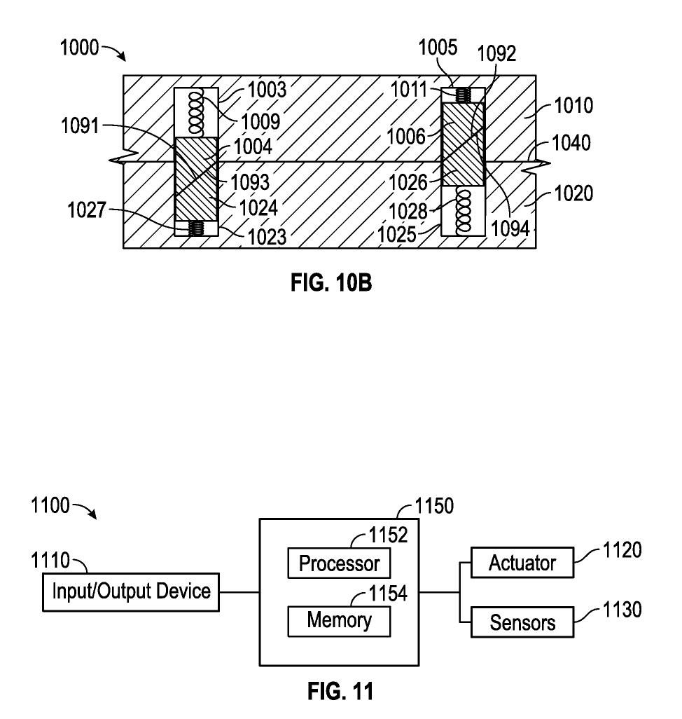

As used herein, the phrase “movable member” refers to either one or both of the rotatable and translated members described herein. Specific applications of the rotatable and translatable members are indicated by context. More particularly, the embodiments of FIGS. 1A-9C and 11-14 depict the movable members as having a rotatable member shape. The embodiments of FIGS. 10A-10B and 14 depict the movable members as having a translatable member shape. As also used herein, the phrase “actuation force” refers to the force used to move the movable members (e.g., rotate the rotatable members and translate the translatable members). The actuation force may include, but is not limited to, gravity (e.g., via an off-centered weight, etc.), a spring force, an electrostatic force, a magnetization force, etc. The actuation force may be provided by an actuation member. The actuation member may include, but is not limited to, off-centered weights, springs, and magnets. Various types of actuation members are described more fully herein.

Referring now to FIGS. 1A-1B, system 100 of engaged objects is shown according to one embodiment. System 100 is formed from first object 110 in an engaged position with second object 120. As used herein, the term “engaged”, “engaged position”, or “engagement position” refers to two or more objects being substantially prevented from relative sliding or translational movement in at least one translational direction. As described more fully below, the engagement of the objects is caused by a movable member of one object being at least partly received in a recess of another object. The recess may be empty or include another movable member, in which case, the two movable members may mate. This is referred to herein as mated members. As shown in FIGS. 1A-1B, a plurality of mated members 150 are formed between first object 110 and second object 120 to engage first object 110 with second object 120. While system 100 depicts only two objects, it should be understood that more than one object may be engaged with a single object depending on the size and shape of each object. Similarly, while the objects shown herein are substantially planar (i.e., rectangular or square prism shaped objects), it should also be understood that the size and shape (e.g., spherical, triangular prism, etc.) may vary based on the application. To that end, the surfaces (e.g., top surface 101 and bottom surface 141 of first object 110) may be planar, convex, concave, etc. Accordingly, the planar surface embodiments shown herein are not meant to be limiting. All such variations are intended to fall within the spirit and scope of the present disclosure.

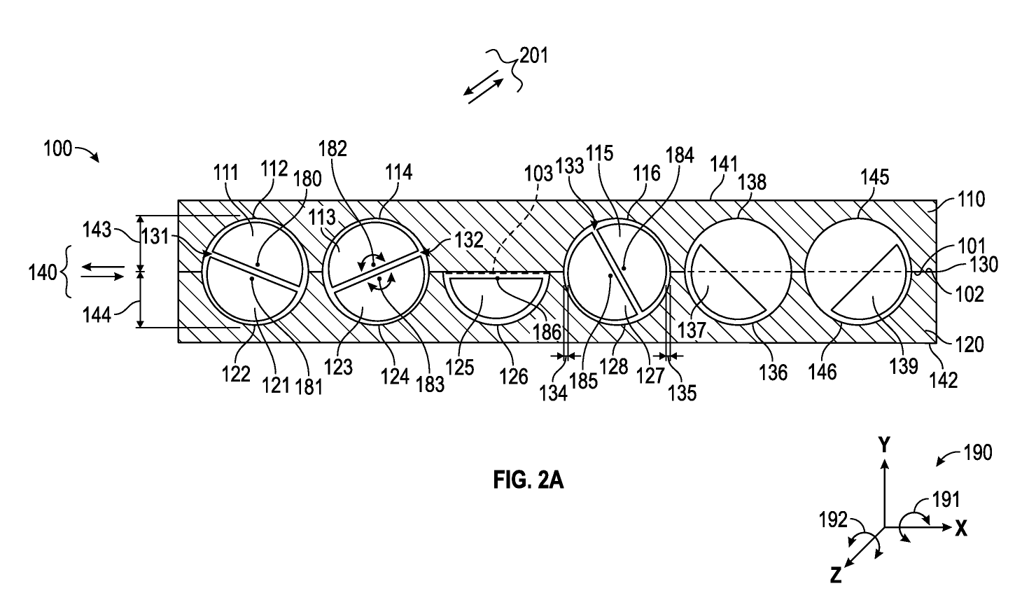

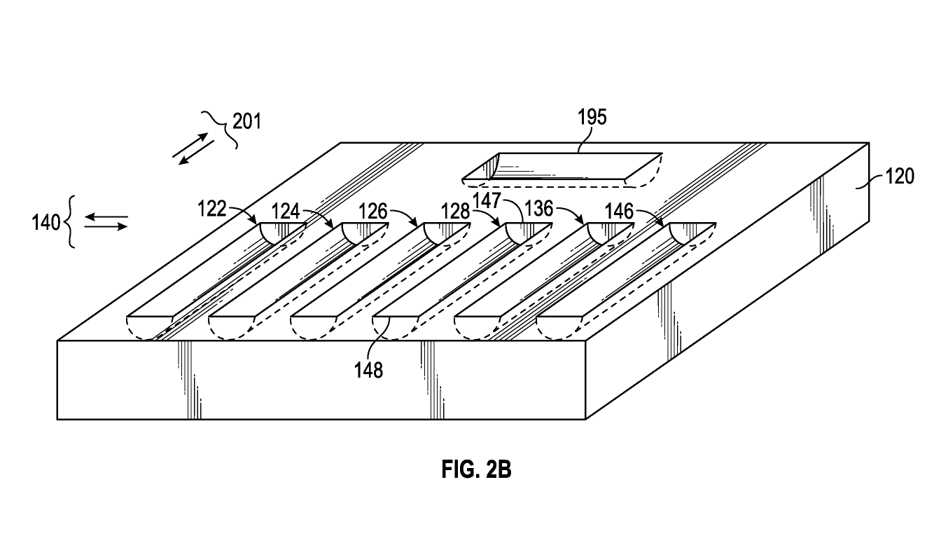

Referring to FIG. 2A, a side cross-sectional view of system 100 is shown, according to one embodiment. As shown, first object 110 includes bottom surface 141 and top surface 101 positioned opposite bottom surface 141. As described herein, the top surface, such as top surface 101 and top surface 102 (of second object 120), may also be referred to as an “engagement surface” (of an object) to indicate the surface(s) where engagement occurs or may occur between two objects. Accordingly, some objects (e.g., triangular-shaped objects, etc.) may have multiple engagement surfaces.

As shown, top surface 101 defines first recess 112 (e.g., notch, groove, cavity, hole, etc.), second recess 114, third recess 116, fourth recess 138, and fifth recess 145. First recess 112, second recess 114, third recess 116, fourth recess 138, and fifth recess 145 extend a distance 143 from top surface 101 toward bottom surface 141. In an alternate embodiment, the recesses may be structured as through-holes through both top surface 101 and bottom surface 141. First object 110 also includes first, second, and third movable members embodied as first rotatable member 111, second rotatable member 113, and third rotatable member 115. First rotatable member 111 is sized to fit within first recess 112, second rotatable member 113 is sized to fit within second recess 114, and third rotatable member 115 is sized to fit within third recess 116.

Like first object 110, second object 120 includes bottom surface 142 positioned opposite top surface 102. Top surface 102 defines first recess 122 (e.g., notch, groove, cavity, hole, etc.), second recess 124, third recess 126, fourth recess 128, fifth recess 136, and sixth recess 146. First recess 122, second recess 124, third recess 126, fourth recess 128, fifth recess 136, and sixth recess 146 extend a distance 144 from top surface 102 toward bottom surface 142. In an alternate embodiment, the recesses may be structured as a through-hole through both top surface 102 and bottom surface 142. Second object 120 also includes first rotatable member 121, second rotatable member 123, third rotatable member 125, fourth rotatable member 127, fifth rotatable member 137, and sixth rotatable member 139. First rotatable member 121 is sized to fit within first recess 122, second rotatable member 123 is sized to fit within second recess 124, third rotatable member 125 is sized to fit within third recess 126, fourth rotatable member 127 is sized to fit within fourth recess 128, fifth rotatable member 137 is sized to fit within fifth recess 136, and sixth rotatable member 139 is sized to fit within sixth recess 146.

Rotatable members 111, 113, 115, 121, 123, 125, 127, 137, and 139 have the same structure and function. The same is true for recesses 112, 122, 114, 124, 116, 126, 128, 136, 138, 145, and 146. Different reference numerals are used for clarity in explanation. Therefore, for clarity and ease of explanation, these structures may be referred to as the “rotatable members of FIG. 2A” and the “recesses of FIG. 2A” when referenced collectively. The rotatable members of FIG. 2A are rotatable between a first range of positions and a second range of positions. In FIG. 2A, a first position in the first range of positions is represented by rotatable member 125. In the first range of positions, the rotatable member is located, positioned, or rests at or below a corresponding top surface. In this case, rotatable member 125 is positioned at or below top surface 102 (for clarity, plane 103 is inserted to depict the offset from rotatable member 125 relative to top surface 102). The second range of positions refers to any position where at least a portion of the rotatable member protrudes above the top surface (e.g., top surfaces 101 and 102). In the example of FIG. 2A, rotatable members 111, 121, 113, 123, 115, 127, 137, and 139 are each in the second position.

Before continuing the description of the FIG. 2A, as used herein, the term “orientation” when referring to a rotatable member refers to the position, based on the angle of rotation, of the rotatable member in its corresponding recess in regard to one plane of rotation. As seen in FIG. 2A, each of the rotatable members are rotated in the z-plane (rotation direction 192). In that regard, rotatable member 125 has a zero-degree angle of rotation. To that end, small angles of rotation correspond with the rotatable member minimally protruding into a mated recess. Large angles of orientation correspond with the rotatable member protruding a relatively greater amount of its body into the mated recess. A ninety-degree angle of rotation indicates a mating surface (e.g., mating surface 613 in FIG. 6) that is oriented perpendicular or substantially perpendicular to an interface (e.g., interface 130) that defines a separation plane between two objects. A ninety-degree rotation angle may be used to reduce the likelihood of perpendicular movement (y-direction in the configuration of FIG. 2A) of the two objects when an excessive amount of sliding force is applied to the objects. Accordingly, this configuration may be utilized when engaged objects are likely to experience excessively-applied sliding forces. As also shown in FIG. 2, rotatable member 137 is at a substantially opposite orientation relative to rotatable member 139. In this regard, an “opposite orientation” refers to an opposite angle of rotation (i.e., a mirror image) relative to an orientation of another rotatable member.

Referring back to FIG. 2A, the rotatable members of FIG. 2A are shaped as half-cylinders. As a half-cylinder, the rotatable members of FIG. 2A may only rotate about one plane of rotation. In this configuration, in regard to coordinate system 190, in the orientation shown, the rotatable members of FIG. 2A may rotate about the z-plane (i.e., rotation direction 192). When the rotatable members of FIG. 2A are mated (e.g., rotatable member 111 and rotatable member 121), a substantially full cylinder shape is formed (e.g., a peg) between the two rotatable members.

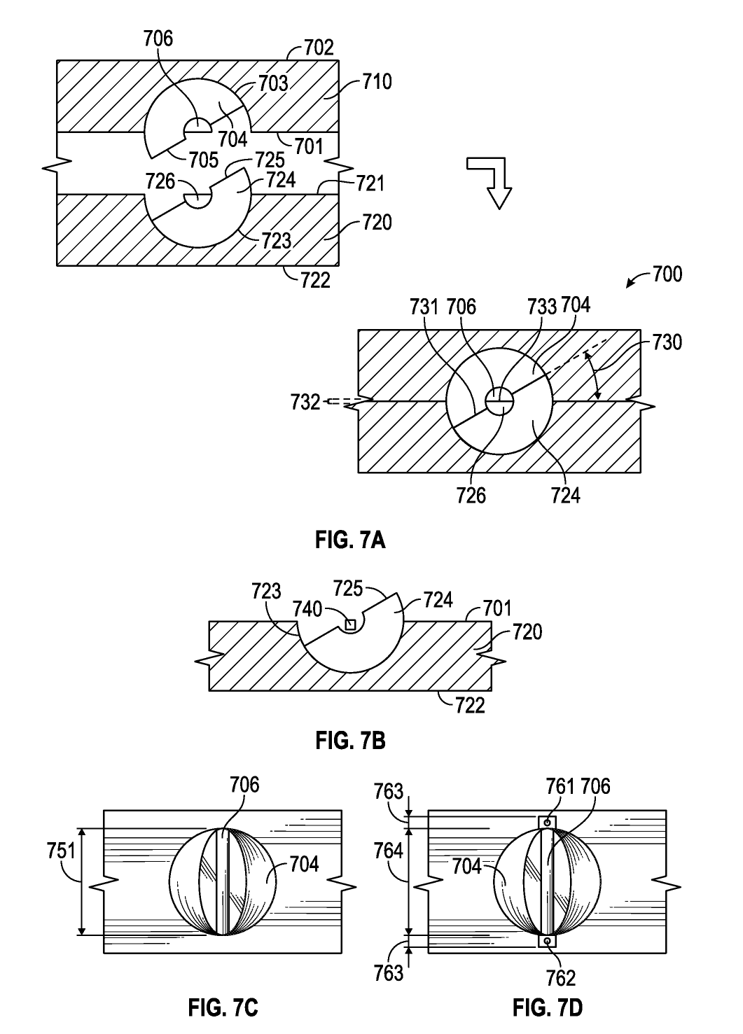

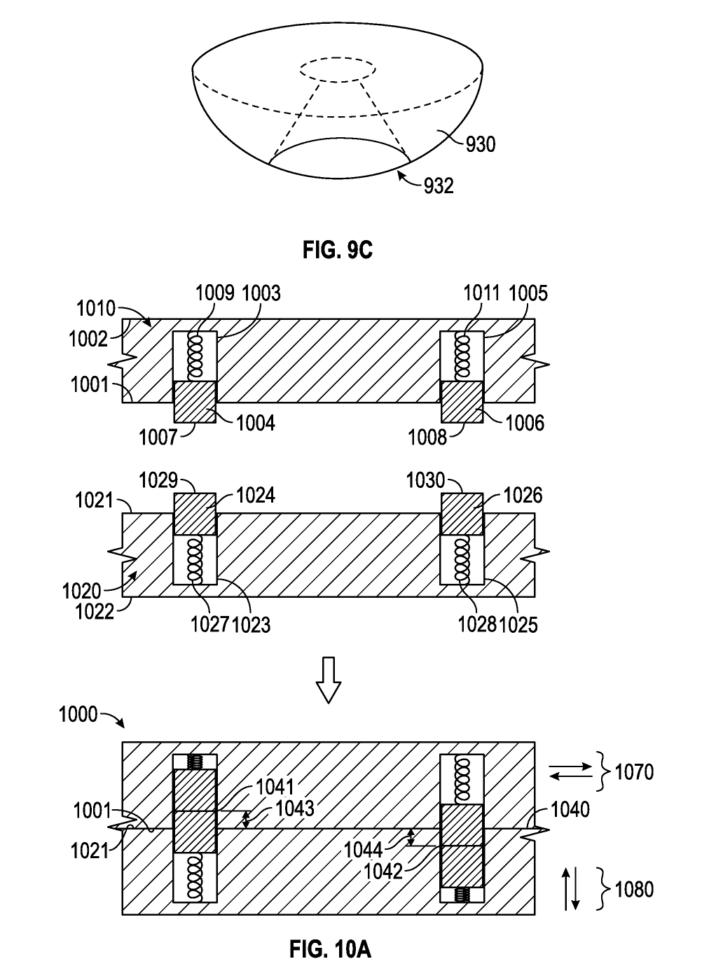

According to other embodiments, the rotatable members may be any shape capable of rotating between the first range and second range of positions. For example, a shape of the rotatable member may include, but is not limited to: a half-sphere, a half-ovoid, and a half-toroid (see FIGS. 7A-7D). For example, compared to a half-cylinder shape, in a half-sphere embodiment, the half-sphere rotatable members may have two planes of rotation. This construction may permit relatively easier mating of rotatable members or a recess of one object that at least partly receives the half-sphere rotatable member of another object. As such, many different configurations of the rotatable members are possible with only a few such configurations being described. As mentioned above, while FIGS. 1A-9C depict the movable members as rotatable (e.g., rotatable member 111), in other embodiments, the movable members may be non-rotatable. For example, the movable member may be a translatable member (e.g., translatable member 1004 of FIG. 10A) that moves between the first and second range of positions to engage the objects. This embodiment is described more fully herein in regard to FIG. 9.

According to one embodiment, the rotatable members of FIG. 2A rotate about a pivot point that is coplanar relative to the top or engagement surface (i.e., plane 103). In the example of FIG. 2A, the rotatable members are attached to the object via an axle (e.g., half-axles 180-186). A half-axle configuration refers to a structure that is substantially half the shape and size of a full axle structure. An example half-axle structure is more clearly shown in FIG. 7A with half-axles 706 and 726. When mated, half-axles 706 and 726 form a full axle (in this case, a cylindrical shaped axle). Accordingly, the half-axle structure corresponds with any axle structure that may be divided in two, such that mated members form a full axle (example full axle structures include, but are not limited to, cylindrical shafts, frusto-conical shafts, etc.). In comparison, a full axle configuration is shown in FIG. 7B (axle 740). In this case, mated members with full axles form two axles whereas mated members with two half-axles only form one axle (see FIG. 7A). Referring back to FIG. 2A, half-axles 180-186 may be attached to each respective object in any location. In the example of FIG. 2A, half axles 180-186 are attached to top surfaces 101 and 102, such that the rotatable members of FIG. 2A may rotate about pivot points coplanar with top surfaces 101, 102. The half-axle (or full axle in some embodiments, see FIG. 7B) may have any shape that permits rotation of the rotatable member (e.g., cylindrical). In some embodiments, rotation constraining mechanisms (see FIG. 6) may be utilized to control the range of rotation of the rotatable member. In alternate embodiments, the rotatable members may be free to rotate (i.e., no constraints, such as in a full axle arrangement without the presence of a rotation constraining mechanism).

As mentioned above, while FIG. 2A depicts half-axles 180-186 positioned on top surfaces 101 and 102, half-axles (or full axles) may be attached to the objects in any position capable of enabling the rotatable members to rotate between the first range of positions and the second range of positions. As such, due to the ability of the objects to be re-used and re-purposed, one object may have axles attached to the top surface (e.g., top surface 101) while another object has axles attached at some point between the top surface and bottom surface. In these cases, rotation of the mated members may be about two different pivot points for each rotatable member. All such variations are intended to be within the spirit and scope of the present disclosure. While only a few rotation point examples for the rotatable members are described above, it should be understood that the rotatable members of the present disclosure may be attached or coupled to their respective object by any mechanism as long as they are able to rotate between a position below the top surface and a position above the top surface to at least partly protrude into a mated recess.

According to one embodiment, to engage first object 110 and second object 120, a rotatable member in the second range of positions of the first object aligns and mates with a rotatable member in the second range of positions of the second object (e.g., rotatable members 121 and 111). According to another embodiment, the engagement may be based on a rotatable member (or movable member) of one object protruding into an empty recess of a second object. According still other embodiments, like that depicted in FIG. 2A, a combination of mated pairs and rotatable members received in empty mated recesses may engage the objects.

In regard to the mated pair engagement embodiment, in the example of FIG. 2A, three rotatable member pairs are mated (i.e., mated members 150 of FIGS. 1A-1B): rotatable members 121 and 111, rotatable members 113 and 123, and rotatable members 115 and 127. As shown, when objects 110 and 120 are engaged, interface 130 defines a separation plane between the two objects is formed. As shown, first interface 131 is formed between rotatable members 111 and 121, second interface 132 is formed between rotatable members 113 and 123, and third interface 133 is formed between rotatable members 115 and 127. As shown, interfaces 131-133 are at an angle relative to interface 130. This angle corresponds to the relative orientation of each mated rotatable member. As also shown, interface 131 is oriented substantially opposite interface 132.

In some embodiments, the rotatable members may be permitted to slide or move within the recess (e.g., in the x- and z-plane). This movement may be permitted based on the attachment device utilized (described below). For example, a spring may permit rotation and translation of the rotatable member. In other cases, like FIG. 2A, the rotatable member (and movable member in general) may only be permitted to translate in one direction. For example, in regard to FIG. 2A, the axles that attach the rotatable members to the objects restrict the ability of the rotatable members to move in the x-plane. However, the recesses of FIG. 2A may be longitudinally longer than the rotatable members of FIG. 2A, such that the rotatable members of FIG. 2A may slide in the z-plane along the axles within their recesses. In still other embodiments, the rotatable or translatable members may only move in their direction used for engagement (e.g., the rotatable member may only rotate and not translate within the recess and the translatable member may only move vertically and not side-to-side within its recess). All variations are intended to fall within the spirit and scope of the present disclosure.

In each configuration, due to contact between a rotatable member and its mated recess, relative sliding in a direction corresponding to arrows 201 is substantially prevented. For example, if first object 110 was slid in an x-plane towards rotatable member 113, rotatable member 111 would impact recess 122 and rotatable member 121 would impact recess 112 (a similar relationship would exist with the other mated members). The interaction between each rotatable member of the mated members and a corresponding mated recess restricts translational movement. In this configuration, translational movement in the x-plane (arrows 140) is substantially restricted, where the x-plane corresponds with one-degree of translational freedom when the objects are oriented as shown in FIG. 2A. Sliding or translational movement in the direction of arrows 140 may be limited by the permissible movement of the mated recess to the received rotatable (or translatable) member. In this example, gap 134 and gap 135 depict the x-plane distance that mated recesses 116 and 128 traverse before impacting mated rotatable members 115 and 128 to stop translation in the x-planes. The opposite is true as well. If one object is held steady and the other object is pushed in the x-plane, at least one of those gaps are traversed by the moved rotatable member before translation in the x-plane is substantially stopped due to the impact of the moved rotatable member and its mated recess. As such and as mentioned below, “substantial” prevention of translation in one direction refers to the distance separating a movable member of one object and a mated recess of another object in one translational direction. As also used herein, the term one translational direction refers to both directions in one-directional plane. For example, arrows 140 correspond with both sliding directions in the x-plane. In comparison, arrows 201 correspond with both sliding directions in the z-plane. Therefore, the arrows 140 and arrows 201 correspond with two translational directions (or two translational degrees of freedom).

The interaction between the mated recess and the rotatable member may also restrict the relative sliding movement of the objects in a second translational direction. In regard to FIG. 2A, the distance separating the rotatable member and the ends of a mated recess may limit the relative sliding or translation amount of two engaged objects in the z-plane. Referring now to FIG. 2B, a top perspective view of second object 120 with the rotatable members removed is depicted according to one embodiment. As shown in FIG. 2B, in regard to FIG. 2A, the recesses defined by second object 120 have the same shape as the rotatable members (i.e., half-cylinder) of second object 120. The same is true for first object 110. Thus, when a mated member is formed, the corresponding aligned recesses form a substantially full cylindrical shape (e.g., recess 112 and recess 122). In various alternate embodiments, the shape of the rotatable member may differ from that of the recess (e.g., a half-cylinder shaped rotatable member and a half-cube shaped recess).

To at least partly prevent translation of objects in the second translation direction (in this case in a direction corresponding to arrows 201), at least one of first end 147 and second end 148 of recess 128 impact rotatable member 115 when rotatable member 115 is in the second range of positions and a sliding force is applied to move the objects in a z-direction. As mentioned above, axles attach the rotatable members to the objects in the example of FIG. 2A. In this situation, the rotatable members are free to slide longitudinally (z-direction) on the axles. Upon impact with one of the longitudinal ends of the mated recess, the sliding movement of first object 110 to second object 120 in a second degree of translational freedom (in this case, the z-direction corresponding to arrows 201) is ceased or substantially ceased.

Depending on the longitudinal gap separating the movable member and the mated recess (in this case, rotatable member 115 and ends 147, 148), the amount of translational movement in at least one translational direction may be controlled. This is similar to the function and structure described in regard to gaps 134, 135. For example, in regard to FIGS. 2A-2B, the half-cylinder shaped recesses may be axially or longitudinally longer than the half-cylinder shaped rotatable members by more than a marginal length, such that the half-cylinder rotatable members are translatable in an axial direction (arrows 201) by more than the marginal length (e.g., along the attachment axles). A marginal length may refer to a length where the rotatable member may be received in the recess but substantially only be allowed to rotate (i.e., no lateral movement in the direction of arrows 201). In turn, a length more than marginal refers to a length where the rotatable member is allowed to move (i.e., slide), while still being rotatable between the first range of positions and the second range of positions. Thus, as can be readily appreciated, many different recess/rotatable member configurations are possible that impact the translational freedom in either one or both of the translational directions (e.g., x-plane and z-direction). For example, a large gap may be provided longitudinally in recess 128 that permits rotatable member 115 to translate further in a z-direction before impacting an end (e.g., ends 147, 148). In comparison, gaps 134, 135 may be minimized. In this configuration, engaged objects 110 and 120 are permitted to translate in one translational directional substantially more than the other translational direction. Of course, these configurations are highly customizable with all such possibilities intended to fall within the spirit and scope of the present disclosure.

Therefore, the term “substantially” when referring to the sliding movement constraint of the objects refers to the smallest gap between a movable member and a mated recess of another object in at least one translational direction. That is, the term “substantially” refers to the distance a movable member may move before impacting its mated recess, which then stops the relative sliding in that direction.

As mentioned above, engagement may also be based on a movable member protruding into an empty recess of a second object. Still referring to FIG. 2A, rotatable members 137 and 139 of second object 120 are shown in the second range of positions. In this configuration, recess 138 is aligned with recess 136 and recess 145 is aligned with recess 146, wherein “aligned” refers to a movable member being permitted to move (e.g., rotate or translate) into a recess of another object. Accordingly, the interaction between the rotatable member and the mated recess engages first object 110 to second object 120. In the configuration depicted, rotatable members 137 and 139 have substantially opposite orientations. Excluding the mated members of FIG. 2A, if rotatable members 137 and 139 have a similar orientation, first object 110 would be permitted to translate in a direction 140 until the mated recesses 138 and 145 come into contact with rotatable members 137 and 139, respectively. With the substantial opposite orientation, the permitted sliding in directions 140 is limited to the gap that separates the mated recesses from the rotatable members in direction 140. In other words, substantial opposite orientations correspond with a relatively lesser amount of relative translational movement in both directions of one translational direction for two objects. Similar orientation corresponds with a reduced amount of relative translational sliding in only one of two directions of one translational direction for two objects. Each configuration (substantially opposite or a similar orientation) may be used depending on the application.

According to one embodiment, a rotatable member of one object may rotate in a plane that is different from the plane of another rotatable member. This configuration is shown in FIG. 2B in regard to recess 195. Recess 195 is longitudinally perpendicular to recesses 122, 124, 126, 128, 136, and 146. As mentioned above, a rotatable member in the second range of positions may impact longitudinal ends of a mated recess (e.g., ends 147 and 148) when the objects are moved relatively in the longitudinal direction. However, at small angles of rotation, a relatively small volume of the rotatable member is protruding into the mated recess. This corresponds with a relatively small surface area that contacts an end of the mated recess. While this limited contact area may be sufficient in some situations, in other situations, a greater contact area may be desired to reduce the likelihood that a slip occurs between a longitudinal end and the rotatable member. In the example of FIGS. 2A-2B, this slip would then allow for z-plane translational movement.

Accordingly, in regard to the rotatable member embodiments, one rotatable member that is used to mate with a recess (or another rotatable member) of a second object rotates about a different rotational plane than the other rotatable members. In regard to the half-cylinder rotatable member embodiment depicted in FIGS. 2A-2B, recess 195 is oriented substantially perpendicular to the other recess to permit rotation about the x-plane (rotation direction 191) versus the other rotatable members that rotate about the z-plane (rotation direction 192). In the half-sphere embodiment, all of the recess orientations may be substantially aligned, but due to the ability of the half-sphere to rotate about two planes, at least one half-sphere rotatable member that protrudes into a recess of the second object is rotated in a different plane from the other half-sphere rotatable members.

Utilizing a different rotation plane, increases the surface area contact zone between a rotatable member and a mated recess in that different plane. Advantageously, this different plane also corresponds with the other translational direction of two objects. In the embodiment of FIGS. 2A-2B, a relatively greater amount of surface area contact zone is provided by the rotatable member received in recess 195 when objects 110, 120 are moved in the z-plane. This type of placement and configuration may be used when a relatively more secure engagement position is desired.

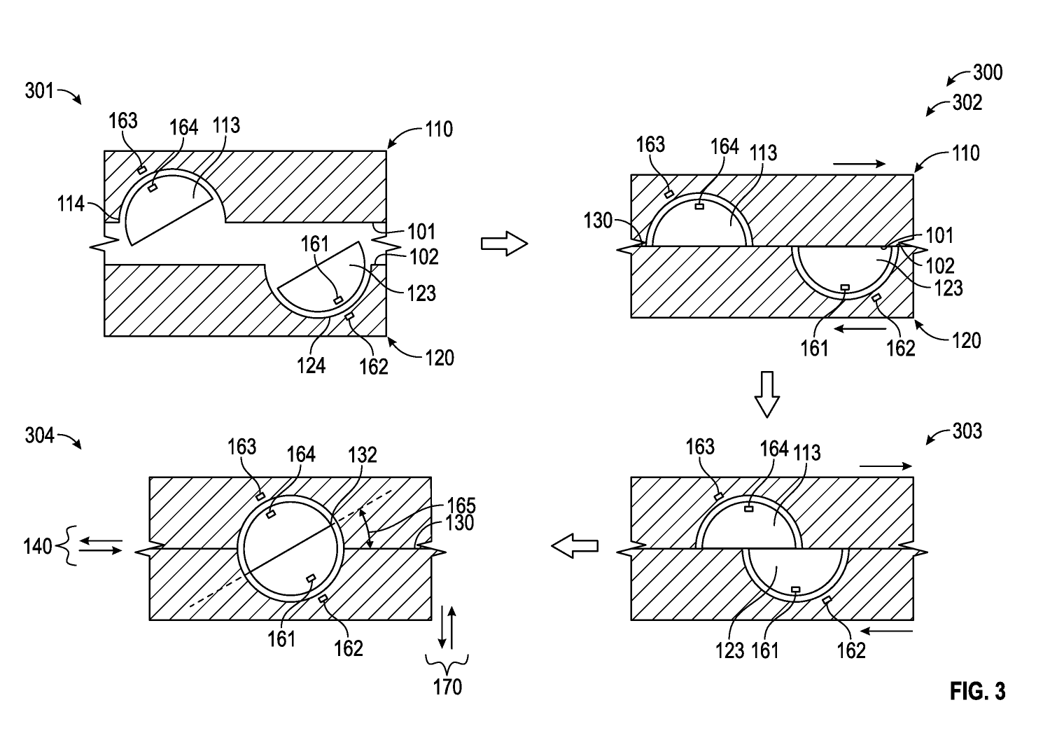

Referring now to FIG. 3, a flow diagram 300 of engaging first object 110 and second object 120 via rotatable members 113 and 123 (see FIG. 2A) is shown according to one embodiment. At step 301, first object 110 and second object 120 are in an adjacent position, and rotatable member 113 and rotatable member 123 are in the second position (i.e., protruding above top surfaces 101, 102 respectively). Initial positioning of the rotatable members (and movable members, in general) is highly configurable. For example, the rotatable members may be initially set in the first range of positions and rotated (or, translated if a translatable member). If there is no corresponding rotatable members to mate with or an empty recess to recess the rotatable member, the rotatable member may remain in the first range of positions. In the example of FIG. 3, rotatable member 123 is held in the second range of positions by magnetic force via magnets 161 and 162. Rotatable member 113 is held in the second position via magnets 163 and 164.

To hold or retain the rotatable member in the recess and permit rotation, many different forms of attachment, holding, or retaining may be utilized. In contrast to the example of FIGS. 2A-2B, in the example of FIG. 3, magnets may be used to hold the rotatable members in the recesses (compared to axles 180-186). While also providing a holding force for an initial position, the magnetic force (e.g., via magnets 161 and 162) may also retain the rotatable member to the object (i.e., prevent the rotatable member from falling out of the recess). In other embodiments, the rotatable member may be in an interference relationship with the top surface defining the recess (e g., minimizing gaps 134 and 135 in FIG. 2). The interference relationship may permit rotation of the rotatable member, but otherwise attach or hold the rotatable member to the object. In various other embodiments, the attachment of the rotatable member to the object may be via an adhesive, a spring, gravity (for upward facing object surfaces) a vacuum, a capillary force, a string, a shaft, and/or any other type of holding force or mechanism that permits the rotatable member to rotate while attaching, holding, or retaining the rotatable member to the object.

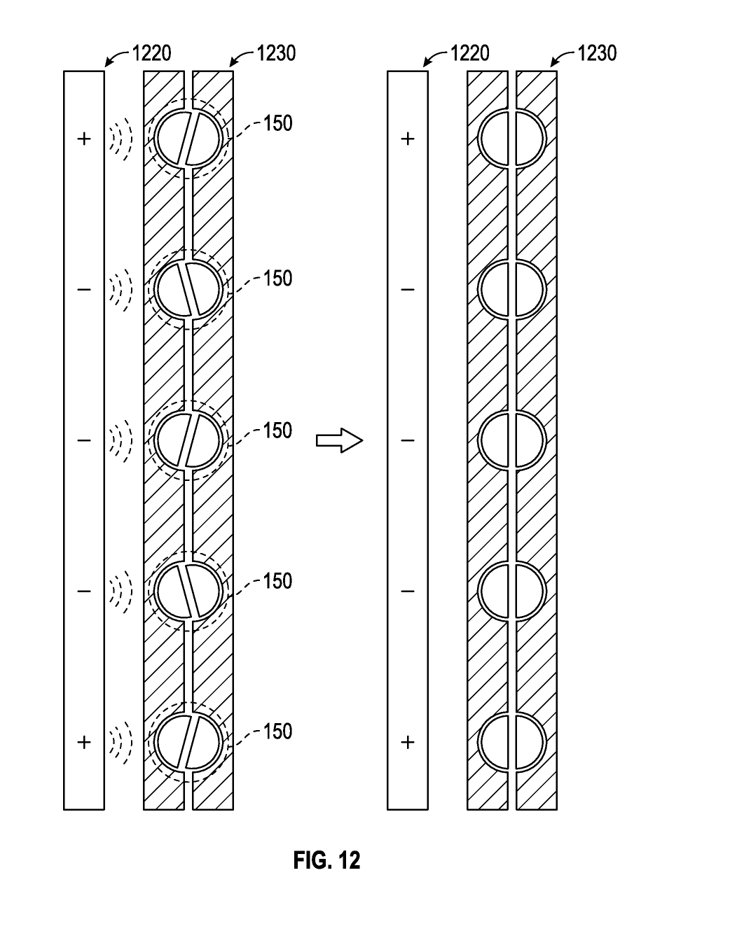

Referring back to FIG. 3, at step 302, first object 110 is brought into substantial contact with second object 120. Interface 130 between first object 110 and second object 120 is shown as a gap, however, in operation top surface 101 and top surface 102 may come into substantial contact and force rotation of rotatable members 113 and 123 into the first range of positions. Accordingly, the substantial contact of top surface 101 and top surface 102 apply a torque to rotatable members 113 and 123 (i.e., overcome the magnetization force of magnets 163 and 164 and magnets 161 and 162) into the first range of positions to permit relative sliding of the two substrates. As mentioned above, in other embodiments, the rotatable (or translatable) members may be initially position in the first range of positions where there are no hindrances to sliding the substrates relative to each other into an engaged position. In still other embodiments, like the example of FIG. 12, one or more rotatable members may be positioned in the second position and an actuator (also referred to herein as an actuation member) may rotate the member to the first position to permit sliding of the surfaces into the full or half locked position. Actuation members are described more fully in regard to FIG. 11.

At step 303, first and second objects 110, 120 are slid into a position to align rotatable members 113 and 123. In other embodiments, one or more movable members of one object may be slid into alignment with one or more empty recesses of another object. In still other embodiments, one or more rotatable (or translatable) members may not align with another rotatable (or translatable) member. This instance is depicted in FIG. 2A with rotatable member 125. Determination of alignment between the object surfaces is intended to be engaged is highly configurable. In one embodiment, the placement (i.e., pattern or distribution) of rotatable members on a top surface of a first object may correspond with a top surface of a second object. In this instance, the top surfaces of the first and second object are specific to each other. In other embodiments, alignment determination may be via one or more alignment standards as described more fully herein.

Referring further to FIG. 3, at step 304, rotatable member 113 is aligned with rotatable member 123. Also at step 304, an actuation force is provided by an actuation member to rotatable members 113 and 123 to cause the rotatable members to rotate into the second range of positions and engage the objects. In this example, the actuation member is structured as magnets 161-164. Magnets 161-164 not only hold rotatable members 113 and 123 to substrates 110 and 110, but also act to rotate the aligned rotatable members 113, 123. Furthermore, due to placement of magnets (in or on) rotatable members 113 and 123 and top surfaces 101, 102, the mated rotatable members are held at angle 165 relative to interface 130 formed between the planar portions (i.e., plane 103) of top surface 101 and top surface 102. Due to interface 132 of rotatable members 113 and 123 being at angle 165 relative to interface 130 of the objects that permit engagement of rotatable members 113 and 123 with their mated recesses, first and second objects 110, 120 are substantially prevented from lateral (or sliding) (shown by direction arrows 140) movement relative to each other. In the example of FIG. 3, the actuation force is provided by magnets. In other embodiments, an external actuation member may provide the actuation force (e.g., magnetic actuation device 1120 of FIG. 12) rather than the actuation member being included with the movable members. As such, other sources of actuation forces may include, but are not limited to, gravity, hydraulics, pneumatics, springs, and the like. These sources of actuation forces are described more fully herein.

According to one embodiment, to disengage the mated rotatable members, an external magnetization force may be applied to actuate a rotation of the rotatable members into the first range of positions to permit disengagement of the objects in a sliding fashion. In another example, first object 110 and second object 120 may be moved in a perpendicular direction, shown by arrows 170 (i.e., y-plane direction of coordinate system 190), relative to each other to unlock the surfaces.

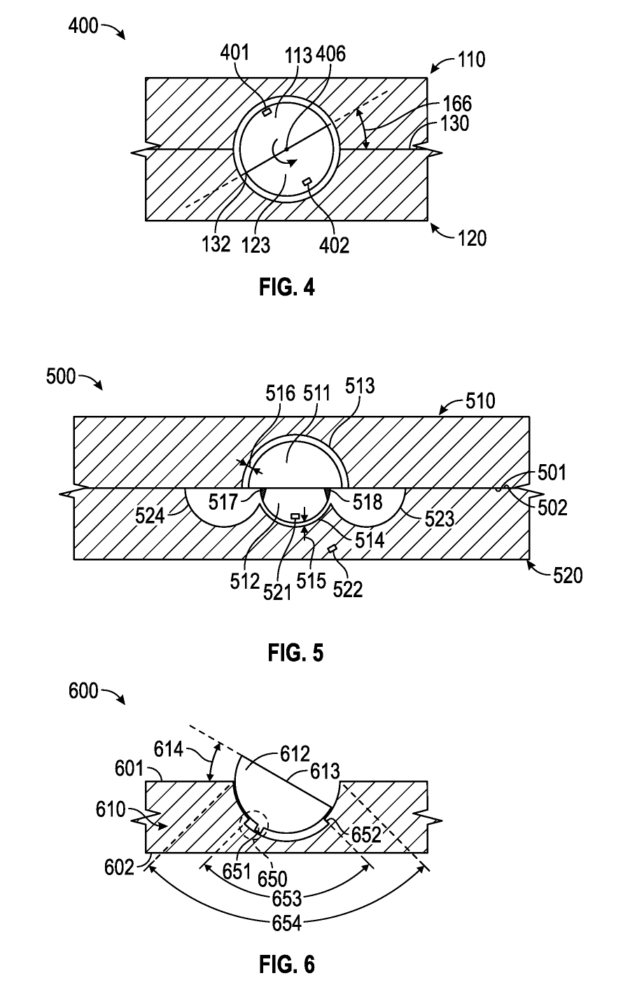

FIGS. 1-3 depict rotatable member embodiments, where the rotatable member may be retained and rotatable via axles (FIG. 2A) and magnets (FIG. 3). As mentioned above, the rotatable members may be held to the object via a variety of different attachment mechanisms (e.g., adhesive, etc.); the rotatable members may come in a variety of different shapes (e.g., half-spheres); and the actuation force used to rotate the rotatable members (e.g., a torque) may be provided by a variety of different actuation members (e.g., a spring). FIGS. 4-9C depict various other embodiments of rotatable members configured to create interlocking surfaces.

FIG. 4 depicts a rotatable member embodiment utilizing an actuation member structured as one or more off-centered weights. FIG. 4 depicts the same components as FIG. 3 except that the actuation force used to rotate rotatable member 113 and rotatable member 123 is caused by off-centered weight 401 and off-centered weight 402. In this instance, when first object 110 and second object 120 are parallel to a ground surface, gravity acts orthogonal to interface 130 and off-centered weights 401 and 402 cause each rotatable member 113, 123 to rotate to mate and form interface 132 at angle 166 relative to interface 130. As shown in FIG. 4, off-centered weights 401 and 402 are positioned on the same side of pivot point 405. Pivot point 405 refers to a point that mated rotatable members 113, 123 rotate about. According to one embodiment, pivot point 406 is coplanar with an interface defined by first object 110 and second object 120. By placing off-centered weights 401 and 402 on the same side, gravity causes rotatable members 113 and 123 (from weights 401 and 402) to rotate counterclockwise 406. If off-centered weights for rotatable members to be mated are positioned on opposite sides of the pivot point, gravity generates competing torques between the rotatable members, which thereby adversely impacts mating of the rotatable members. As such, to engage objects 110 and 120 via rotatable members 113 and 123 using off-centered weights 401 and 402, only rotatable members with off-centered weights on the same side may mate to engage the objects. In this instance, only certain orientations of objects 110 and 120 may coincide with the ability to engage first object 110 with second object 120. In certain other embodiments, the mass of off-centered weights 401 and 402 may differ. As such, if off-centered weights are positioned opposite the pivot point, the rotatable members may still mate due to one off-centered weight causing rotation of both rotatable members.

According to one embodiment, off-centered weights 401 and 402 cause rotatable members 113 and 123 to be unstable at small degrees of rotation and stable at large degrees of rotation. For example, by placing off-centered weights 401 and 402 near the edges of rotatable members 113 and 123 as shown in FIG. 2A, when objects 110 and 120 are orthogonal to a ground surface, weights 401 and 402 are inclined to “fall” nearest the ground surface, which causes rotation of rotatable members 401 and 402 and corresponds with an approximate ninety-degree rotation relative to pivot point 405. Without an intervening mechanism (e.g., a stop rotation mechanism), rotatable members 113 and 123 may not be able to only rotate a small degrees of rotation relative to pivot point 405 without “falling” to a rest position nearest the ground surface. Accordingly, at large degrees of rotation, the off-centered weights cause the rotatable members to achieve a relatively more stable mated position than at small degrees of rotation.

To disengage the surfaces, the joined objects may be manipulated (i.e., moved relative to the ground surface) such that each off-centered weight 401 and 402 causes rotatable members 113 and 123 to rotate into the first range of positions to enable disengagement of objects 110 and 120 in a slide fashion.

FIG. 5 depicts system 500 utilizing additional cavities 523, 524 (e.g., groove, recess, channel, etc.). Generally, FIG. 5 depicts at least one of a different sized rotatable member and an example configuration for a surrounding portion of the recess. The different sizes of at least one of the rotatable member and recess enable alignment of rotatable members to be achieved relatively easier.

As shown, system 500 includes a first object 510 adjacent with second object 520. Top surface 501 of first object 510 defines first recess 513 and gap 516 relative to first rotatable member 511. Top surface 502 of second object 520 defines second recess 514 gap 515, and cavities 523, 524 that surround second rotatable member 512. Cavities 523, 524 permit ready engagement with first rotatable member 511. To that end, cavities 523, 524 permit imperfect alignment to still engage first object 510 with second object 520. In this regard, cavities 523, 524 may function analogously to an empty recess. While cavities 523, 524 are shown to have a similar shape as recesses 513, 514, in other embodiments, cavities 523 and 524 may have any shape desired. As shown, magnets 521 and 522 hold rotatable member 512 to object 520 within recess 514. In other embodiments, for example embodiments that utilize a spring to attach the rotatable member or translatable member to the object, the rotatable or translatable member may be undersized relative to a surrounding recess. This configuration permits a corresponding movable member on another object to mate with a relatively smaller movable member due to the accommodating/oversized recess. Thus, in certain embodiments, at least one of a rotatable member and its corresponding recess for an object is at least one of oversized and undersized. Utilizing a variety of different shapes/sizes may permit an ease of alignment of rotatable members. Moreover, as mentioned above, the size differentials may cause relatively larger (in some embodiments, therefore, heavier) rotatable members to apply torque (i.e., the actuation force) to smaller mated rotatable members to thereby cause the mated members to move into an engaged position for the corresponding objects.

FIG. 5 also depicts rotatable member 512 including tapered (e.g., beveled, chamfered, rounded, etc.) edges 517 and 518. Edges 517 and 518 are structured to aid alignment of rotatable member 511 and rotatable member 512. As rotatable members 511 and 512 are slid into the mated position (e.g., step 303 of FIG. 3), off-centered weights, magnets, or any other actuation device that causes rotatable members 511 and 512 to transition to the mated position may cause a torque that rotates the rotatable members into an interference position. In the interference position, the rotatable members may hinder each other from rotating into the second position. Implementation of edges 517 and 518 prevents or substantially prevents the formation of an interference position and enables alignment of rotatable members 511 and 512. In various other embodiments, other types of alignment-easing devices, mechanisms, and materials may be utilized. For example, a lubricant may be applied to edges of the rotatable member(s) to further aid alignment.

Referring now to FIG. 6, an example rotation constraining mechanism 650 is shown, according to one embodiment. As shown, FIG. 6 depicts object 610 including top surface 601 positioned opposite bottom surface 602. Top surface 601 defines recess 611 and groove 652 (e.g., pit, notch, etc.) in recess 611. Recess 611 extends from top surface 601 toward bottom surface 602, and groove 652 extends to a depth closer to bottom surface 602 than recess 611. Like in the other embodiments, recess 611 substantially constrains lateral motion of rotatable member 612.

According to one embodiment, rotatable member (e.g., rotatable member 612) may rotate to a maximum of ninety-degrees. Rotation angle 614 is defined by the angle between mating surface 613 (for engaging with either another rotatable member or a top surface of another object) and top surface 601. As mentioned above, the rotation angle relative to one plane of rotation refers to the orientation of the rotatable member. In other embodiments, the rotation angle may be angle less than ninety-degrees (e.g., forty-five degrees, sixty-degrees, etc.). As shown, object 610 includes rotation constraining mechanism 650. Mechanism 650 includes protrusion 651 (e.g., detent, bump, dimple, projection, etc.) attached to rotatable member 612, and groove 652. Protrusion 651 is received in groove 652. Therefore, groove 652 has a relatively larger shape than protrusion 651. According to one embodiment, groove 652 extends about a smaller circumferential area than recess 611. Accordingly, interaction of protrusion 651 and groove 652 control rotation of rotatable member 612, where rotation of rotatable member 612 is at a maximum angle 653 that is less than the circumferential angle 654 of recess 611 (i.e., angle 654 defines the angle of rotation of recess 611). In this example, rotatable member 612 has angle of rotation 653 that is less than angle 654 of recess 611. In the example shown, angle 654 is approximately equal to one-hundred and eighty degrees. In other embodiments, angle 654 may be less than one-hundred and eighty degrees. For example, chamfered edges may be included on top surface 601, such that angle 654 is only approximately equal to one-hundred and seventy eight degrees. All such variations are intended to fall within the spirit and scope of the present disclosure.

Protrusion 651 and groove 652 may be formed in any shape as long as their interaction constrains rotation of rotatable member 612. For example, a shape of protrusion 651 may include, but is not limited to, a cylinder, a rectangular prism, a cube, a triangular prism, and a hexagonal prism. The shape of groove 652 may correspond with the shape of protrusion 651 (e.g., a cylinder, a rectangular prism, at least partially spherical, a cube, a triangular prism, hexagonal prism, etc.), correspond with the shape of recess 611, or may differ from the shape of at least one of recess 611 and groove 652. Accordingly, many sizes and shapes of protrusion 651 and groove 652 may be utilized.

Referring collectively now to FIGS. 7A-7D, another shape of a rotatable member is shown, according to one embodiment. In the example of FIGS. 7A-7D, rotatable members 704 and 724 are half-toroid shaped. As shown, first object 710 includes bottom surface 702 and top surface 701 positioned opposite bottom surface 702. Top surface 701 defines recess 703 (e.g., notch, groove, cavity, hole, etc.). Recess 703 extends a distance from top surface 701 toward bottom surface 702. First object 710 also includes rotatable member 704. Rotatable member 704 includes mating surface 705. Rotatable member 704 is sized to fit within recess 703. As mentioned above, rotatable member 704 is half-toroid shaped. Due to this shape, first object 710 also includes half-axle 706. Half-axle 706 may be attached to top surface 701. Rotatable member 704 is structured to rotate about half-axle 706, which is substantially in the same plane as top surface 701. Like first object 710, second object 720 includes bottom surface 722 positioned opposite top surface 721. Top surface 721 defines recess 723 (e.g., notch, groove, cavity, hole, etc.). Recess 723 extends a distance between top surface 721 and bottom surface 722. Second object 720 also includes rotatable member 724 that is sized to fit within recess 723. Rotatable member 724 includes mating surface 725. Rotatable member 724 is also half-toroid shaped. Accordingly, second object 720 includes half-axle 726 that may be attached to top surface 721. Rotatable member 724 rotates about half-axle 726 that is substantially in the same plane as top surface 721.

System 700 depicts interlocked first object 710 and second object 720. In this position, interface 731 formed between interlocking surface 705 and interlocking surface 725 is at angle 730 relative to interface 732 formed between top surfaces 701 and 702. Interface 733 formed between half-axles 706 and 726 may be aligned with interface 730. Due to interface 733 being different than interface 731, first object 710 may be “interlocked” with second object 720. In this configuration, not only is translational or sliding movement substantially prevented, but movement in a direction perpendicular to the translational direction (in this case with regard to the coordinate system 190 of FIG. 2A, the perpendicular direction corresponds with the y-plane). Accordingly, while an “engaged” position refers to substantial prevention of relative sliding or translational movement in at least one translational direction, “interlocked” refers to an engaged position plus an additional movement constraint: a direction perpendicular to the sliding planes (e.g., the x- and y-planes of FIG. 2A).

According to one embodiment, mating surfaces 725 and 705 may include at least one of a coating and a texturing. The coating may include at least one of a lubricant, an adhesive, and a hard coating (e.g., a diamond coating, a titanium-nitride coating, etc.). The texturing may be at a magnitude of at least one of a micro-scale and a nano-scale. In other words, rather than substantially flat mating surfaces 725 and 705, nanometer etching/texturing (or other magnitude) may be present to increase the friction between two mating surfaces. The choice of magnitude of the texturing may vary based on the application (e.g., nano-scale etching for a microeletromechanical system 20 micrometers in size).

According to one embodiment, at least one of the texturing and the coating may be arranged in a pattern that affects rotation of the rotatable member. For example, relatively larger and heavier spikes or texturing may be present on one side of rotatable member 725 (using half-axle 726 as separation point) than on the other. Due to gravity, this additional weighting may cause rotatable member 724 to rotate to the second position to interlock with rotatable member 704. Thus, the at least one texturing and/or coating may be patterned to affect rotation (i.e., mating surfaces 705 and 726 may slip or stick at different orientations). In other embodiments, the texturing or coating may distributed at random on mating surfaces 725 and 705. In certain embodiments, the texturing and/or coating may be used to create a stronger bond between mating surfaces 725 and 705 (e.g., via an adhesive) and/or help them to freely lock and unlock surfaces 725 and 705 (e.g., via a lubricant). Accordingly, while the interlocking surface structure is described in regard to FIGS. 7A-7D, it should be understood that texturing and/or coating may be applied to any movable member surface to aid interlocking and/or engagement.

As shown in FIG. 7A, half-axles 706 and 726 may combine to form a full axle in system 700. However, in other embodiments, the half-axle may be replaced with a full axle. This is shown in FIG. 7B, where full axle 740 is smaller in size than half-axle 706. When rotatable members are mated, full axle 740 may not contact a corresponding full axle thereby allowing the rotatable members to mate without the axles being flush.

FIGS. 7C-7D show example (full or half) axle attachments to the objects. In FIG. 7C, a top view of system 700 is shown according to one embodiment. In this case, half-axle 706 extends substantially the same distance 751 as a diameter rotatable member 704. In FIG. 7D, half-axle 706 extends past a diameter 764 of rotatable member 704 by distances 763. In this instance, fasteners 761 and 762 (e.g., screws, nails, adhesive, pins, welds, etc.) may attach axle 706 to first object 710 and hold rotatable member 704 to object 710. The axles (full or half) may be attached to the object via any attachment mechanism including, but not limited to, 3-D printing, screws, welds, glue, etc.

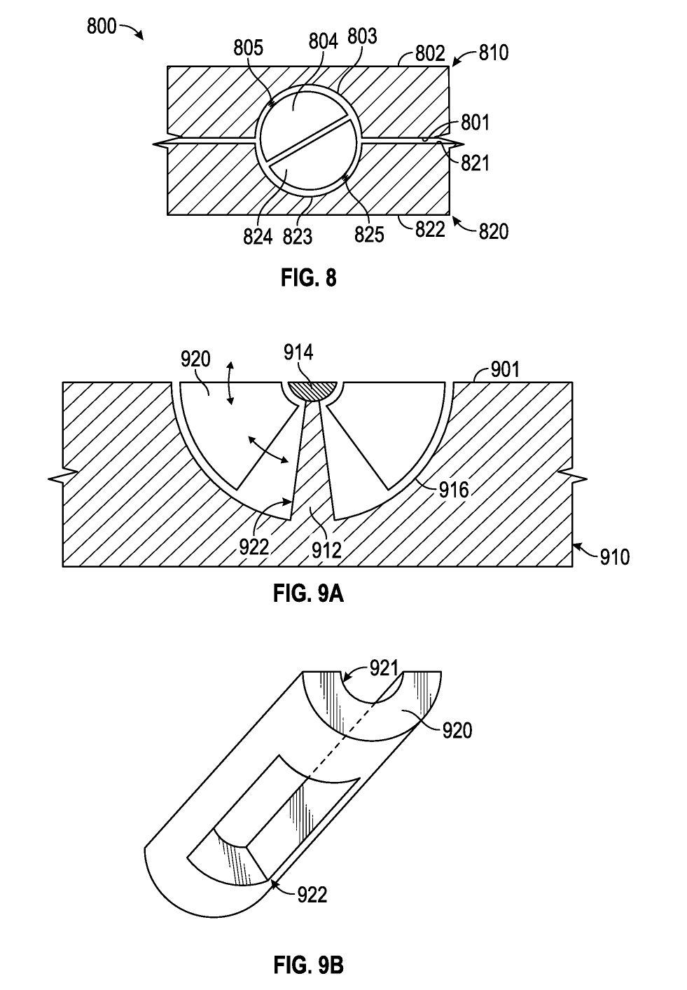

Referring now to FIG. 8, an attachment mechanism for coupling a rotatable member to an object is shown, according to one embodiment. Similar to the other embodiments described above, system 800 depicts first object 810 engaged to second object 820. First object 810 includes top surface 801 positioned opposite bottom surface 802. Top surface 801 defines recess 803 that extends a distance from top surface 801 toward bottom surface 802. First object 810 also includes rotatable member 804. Second object 820 includes top surface 821 positioned opposite bottom surface 822. Top surface 821 defines recess 823 that extends a distance from top surface 821 toward bottom surface 822. Second object 820 also includes rotatable member 824.

In addition to the magnets (FIG. 3) and off-centered weights (FIG. 4), the actuation member that provides the actuation force may also be structured as one or more springs. Accordingly, FIG. 8 depicts rotatable members 804 and 824 attached to first and second objects 810 and 820 via springs 805 and 825. Springs 805 and 825 not only hold rotatable members 804 and 824 to objects 810 and 820 and provide the actuation force, but also constrain rotation depending on the rigidity of the spring used. Springs 805 and 825 may also constrain the translational movement of rotatable members in the recesses. Springs 805 and 825 may be attached to rotatable members 804, 824 and objects 810, 820 in any location as long as rotatable members 804, 824 are able to rotate between the first range of positions and the second range of positions. Mated rotatable members (e.g., rotatable members 804, 824) may have springs attached at different locations (e.g., one spring is attached to a center point of one rotatable member and another spring is attached to the left side of the other rotatable member). In turn, when the rotatable members are aligned, the force provided by the springs (i.e., actuation force) may cause the rotatable members to rotate into the second range of positions to engage the objects. Similarly, the spring rigidity (i.e., stiffness) may vary based on the application and for mated members, to also provide the torque needed to rotate the members into the second position to engage or interlock the objects. While springs 805 and 825 are depicted, it should be understood that many other attachment and actuation members (i.e., that provide the actuation force), such as the magnets described above, may also be used to attach and rotate the rotatable members (e.g., strings, shafts (movable or stationary), etc.). All such variations are intended to be within the spirit and scope of the present disclosure.

Referring to FIGS. 9A-9C, an example rotation constraining and attachment or retention device for rotatable members is shown according to one embodiment. As shown, first object 910 includes rotatable member 920 received in recess 916 defined by first object 910. First object 910 also defines post 912 (e.g., pin, peg, fin, etc.) interconnected to an attachment device, shown as half-sphere 914. As shown, post 912 extends towards top surface 901. A top surface of half-sphere 914 is shown to be coplanar with top surface 901. Rotatable member 920 defines a cavity 922 extending upwards (i.e., towards top surface 901) to cup 921. Cup 921 receives half-sphere 914. In other embodiments, the shape and size of cavity 922 and cup 921 may be any shape and size to accommodate the retention device.

In operation, post 912 restricts rotation of rotatable member 920. A user may control the amount of rotation of rotatable member 920 by increasing or decreasing the gap between post 912 and cavity 922. Half-sphere 914 is structured to hold-down rotatable member 920 in recess 916. For example, when object 910 is rotated one-hundred and eighty degrees, due to the interaction between half-sphere 914 and cup 921, rotatable member 920 is prevent from dropping out of recess 916.

FIG. 9B depicts a half-sphere rotatable member embodiment. In this configuration, cavity 932 defined by rotatable member 930 (shown as a half-sphere) may be sized to provide a gap surrounding post 912. In turn, half-sphere rotatable member 930 may rotate about two planes of rotation about half-sphere 914 before the surfaces of rotatable member 930 that define cavity 932 contact post 912 and prohibit additional rotation.

Accordingly, FIGS. 9A-9C depict additional retention and rotation constraining mechanisms. To construct these embodiments, the rotatable member may be cast around the object. In other embodiments, the rotatable member may include flexion properties that permit it to be relatively deformed and inserted in the recess. In any situation, these configurations permit relatively easy manufacturing of engaging objects of the present disclosure.

Referring now to FIG. 10, system 1000 including a movable member for engaging surfaces is shown according to another embodiment. Rather than the rotatable members of FIGS. 1A-9C, system 1000 uses translatable members. System 1000 depicts an engaged position of first object 1010 and second object 1020. As mentioned above, in the engaged position, first object 1010 and second object 1020 are substantially prevented from relative translation sliding in at least one translational or sliding direction (one translational direction corresponds with arrows 1070). First object 1010 includes top surface 1001 positioned opposite bottom surface 1002. Top surface 1001 defines first recess 1003 (e.g., groove, hole, cavity, notch, etc.) and second recess 1005, wherein recesses 1003 and 1005 extend a distance from top surface 1001 toward bottom surface 1002. First object 1010 also includes first translatable member 1004 sized to fit within first recess 1003 and second translatable member 1006 sized to fit within second recess 1005. First translatable member 1004 includes first mating surface 1007 and second translatable member 1006 includes second mating surface 908. First and second translatable members 1004, 1006 are attached to first object 1010 via springs 1009 and 1011.

Like first object 1010, second object 1020 includes top surface 1021 positioned opposite bottom surface 1022. Top surface 1021 defines first recess 1023 and second recess 1025, and recesses 1023 and 1025 extend a distance from top surface 1021 toward bottom surface 1022. Second object 1020 also includes first translatable member 1024 sized to fit within first recess 1023 and second translatable member 1026 sized to fit within second recess 1025. First translatable member 1024 includes first mating surface 1029 and second translatable member 1026 includes second mating surface 1030. First and second translatable members 1024, 1026 are attached to second object 1020 via springs 1027 and 1028.

Mating surfaces 1007, 1008, 1029, and 1030 may have the same structure and features as described above (e.g., a texturing and/or coating, beveled or modified edges for easy alignment, etc.). Similarly, recesses 1003, 1005, 1023, and 1025 may have the same or different shape from their respective translatable member (e.g., recess 1003 corresponds with translatable member 1004). For example, recess 1003 may be cube-shaped (i.e., four walls) while translatable member 1004 may be hexagonal shaped (i.e., six walls). Accordingly, a shape of the translatable member and corresponding recess may include, but is not limited to, hexagonal shaped, cubed, octagonal, cylindrical, and any other shape that is translatable that may interact with another translatable member (or a recess for the translatable member) to substantially lock two objects together. Furthermore, at least one of the recesses and translatable members may be over/under-sized. In this regard, by oversizing recesses 1003, 1005, 1023, and 1025 relative to their corresponding translatable members, additional lateral movement (arrows 1070 or z-plane (into the page)) may be achieved than if the translatable members and recesses are in more of an interference-type relationship. Not only may oversizing the recesses permit relatively easier engagement, a user may control the amount of relative sliding in at least one translational direction. This is similar to the function and structure described herein above in regard to FIGS. 2A-2B.

Like the rotatable members, translatable members 1004, 1006, 1024, and 1026 are movable between a first range of positions and a second range of positions. In the first range of positions, translatable members 1004, 1006, 1024, and 1026 are below top surfaces 1021 and 1001. In the second range of positions, at least a part of the translatable member is above top surfaces 1001 and 1021.

To cause movement between the first range and second range of positions (i.e., to provide the actuation force), in the example of FIG. 10A, the actuation member is structured as springs 1009, 1011, 1027, and 1028. According to one embodiment, the springs may have differing stiffnesses for translatable members intended to be mated. For example, spring 1011 may be longer (in transverse direction 1080) than spring 1028. Spring 1011 may also be relatively more stiff than spring 1028. Due to these characteristics, spring 1011 pushes translatable member 1006 into translatable member 1026 and compresses spring 1028 attached to translatable member 1026. As a result, interface 1042 formed between mating surfaces 1008 and 1030 of translatable members 1006 and 1026 may be below (using transverse direction arrows 1080) interface 1040 defining the separation plane between the two objects 1010 and 1020. Conversely, spring 1027 pushes translatable member 1024 into translatable member 1004 to compress spring 1009. As a result, interface 1041 formed between mating surfaces 1007 and 1029 of translatable members 1004 and 1024 may be above (using transverse direction arrows 1080) interface 1040. Due to offset 1043 of interface 1041 relative to interface 1040 and offset 1042 relative to interface 1040 that cause contact between the translatable member and its mated recess in at least one translation direction, translational or sliding movement of objects 1010 and 1020 is substantially prevented in at least one translational direction.

Thus, in one embodiment, to prevent objects 1010 and 1020 from becoming disengaged, at least one interface formed from the translatable members is offset from the interface defining the separation plane between the objects. As a result, one mated member is in the first range of positions while the other mated member is in the second range of positions.

According to alternate embodiments, in place of or in addition to a spring, other actuation members may be used (e.g., an expandable and collapsible shaft). An expandable and collapsible shaft may be utilized to allow for the translatable members to engage with a recess of another object while preventing them for individual translational movement within their own recesses. In another example, a position-holding substance may be situated between the translatable member and the top surface. The position holding substance may be used to hold the translatable member within the recess and push the translatable into the second range of or first range of positions. For example, an expanding foam may be situated between the translatable member that is activated via a thermal catalyst (e.g., heat). When the objects are placed in an engaged position, heat is applied to expand the foam and cause the translatable member to move and engage the objects. The position holding substance may include, but is not limited to, an adhesive, a clay, a wax, a gel, or any other type of material may be utilized.

FIG. 10B depicts another translatable member embodiment. In this regard, the system shown in FIG. 10A is identical in FIG. 10B except for the shape of translatable members 1004, 1006, 1024, and 1026. As shown, translatable members 1004, 1006, 1024, and 1026 are shaped to have sloped mating surfaces 1091, 1092, 1093, and 1094. In other embodiments, translatable members 1004, 1006, 1024, and 1026 may have pointed mating surfaces compared to the one-sloped surface of FIG. 10B. The sloped mating surfaces 1091, 1092, 1093, and 1094 may be utilized to permit mating of imperfectly aligned recesses/translatable members to engage two or more objects.

Referring now to FIG. 11, control system 1100 for selectively engaging and disengaging objects is shown, according to one embodiment. Control system 1100 includes processing circuit 1150 communicably coupled to input/output (I/O) device 1110, actuator 1120, and sensors 113. Communication between and among the components of FIG. 11 may be via any number of wired or wireless protocols. For example, a wired system may include a serial cable, a fiber optic cable, a CAT5 cable, universal serial bus (USB; including all micro, mini, and standard types), twisted-pair cables, coaxial cables, and/or any other form of wired connection. In comparison, a wireless system may include the Internet, cellular, radio, Wi-Fi, a wireless local area network (WLAN), Bluetooth, radio frequency (RF), optical communication, infrared, microwave, sonic and ultrasonic waves, and electromagnetic induction communications platforms.

As shown in FIG. 11, processing circuit 1150 includes processor 1152 and memory device 1154. In some embodiments, the functions of processing circuit 1150 described herein are performed by instructions (e.g., software) on machine-readable media and utilize various hardware components. Processor 1152 may be implemented as a general-purpose processor, an application specific integrated circuit (ASIC), one or more field programmable gate arrays (FPGAs), a digital-signal-processor (DSP), a group of processing components, or other suitable electronic processing components. Memory device 1154 may be configured as one or more memory devices, which are configured to store various pieces data regarding objects(s) to be engaged and/or interlocked (e.g., pattern of recess/movable member per the substrate, pattern of texturing/coating on mating surface of movable member of substrate, size and shape of substrate, material of object and/or movable member, etc.). Memory device 1154 may include database components, object code components, script components, or any other type of information structure for supporting the various activities and information structures described herein. Memory device 1154 may be communicably connected to processor 1152 and provide computer code or instructions for executing the processes described herein.

I/O device 1110 is structured to allow an operator or user of control system 1100 to define one or more parameters relating to an engagement or interlocking of two or more objects. One or more parameters may include how/when the object is engaged/disengaged (e.g., via actuator 1120). The one or more parameters are received by processing circuit 1150 and communicated to actuator 1120 to implement the designated parameters. I/O device 1110 may include a graphical user interface, such as a touchscreen, and/or any other interface capable of allowing communications between a user or operator and processing circuit 1150 (e.g., a phone, a computer, etc.).

The objects may include the same structure and functions as described above in regard to FIGS. 1A-10B. For example, the object may include rotatable members (e.g., rotatable member 111) and/or translatable member(s) (e.g., translatable 1004). The rotatable and/or translatable member may be attached to the object via any attachment mechanism (e.g., a spring, a string, an adhesive, a shaft, an axle, etc.). Moreover, the actuation force may be provided by any type of actuation member (e.g., magnets, springs, etc.). In the example of FIG. 11, the actuation force is provided by actuator 1120.

Processing circuit 1150 is structured to control actuator 1120 to selectively engage/disengage or interlock one or more objects. For example, via I/O device 1110, an unlock or disengagement code may be received by processing circuit 1150 such that processing circuit 1150 sends an unlock command to actuator 1120 to unlock or disengage the one or more interlocked or engaged objects.

Actuator 1120 is structured as any device or mechanism that locks/unlocks or engages/disengages one or more objects. Actuator 1120 may include a hydraulic device, a pneumatic device, a magnetic device, and any other actuation force-providing device that causes the movable members of the object to move into the first range of positions to permit disengagement of the engaged objects. For example, FIG. 12 depicts actuator 1120 embodied as an external magnetic device 1220. Magnetic device 1220 includes specifically placed positive (+) and negative (−) magnetic poles. When magnetic device 1220 is placed into a position near objects 1230, mated members 150 rotate into the first range of positions thereby permitting slide disengagement of objects 1230. Thus, the shape, size, and placement of magnetic poles may vary based on the location of movable members on the object(s). In this regard, magnetic device 1220 acts as a key for the specific objects 1230. If a magnetic device with differently placed magnetic poles was used, movable members 150 may rotate but not all into the first range of positions to allow slide disengagement of objects 1230. An example application of the actuator-object system of FIG. 12 may be with commercial or residential safes, where the actuator-magnetic device serves as the key for the safe.

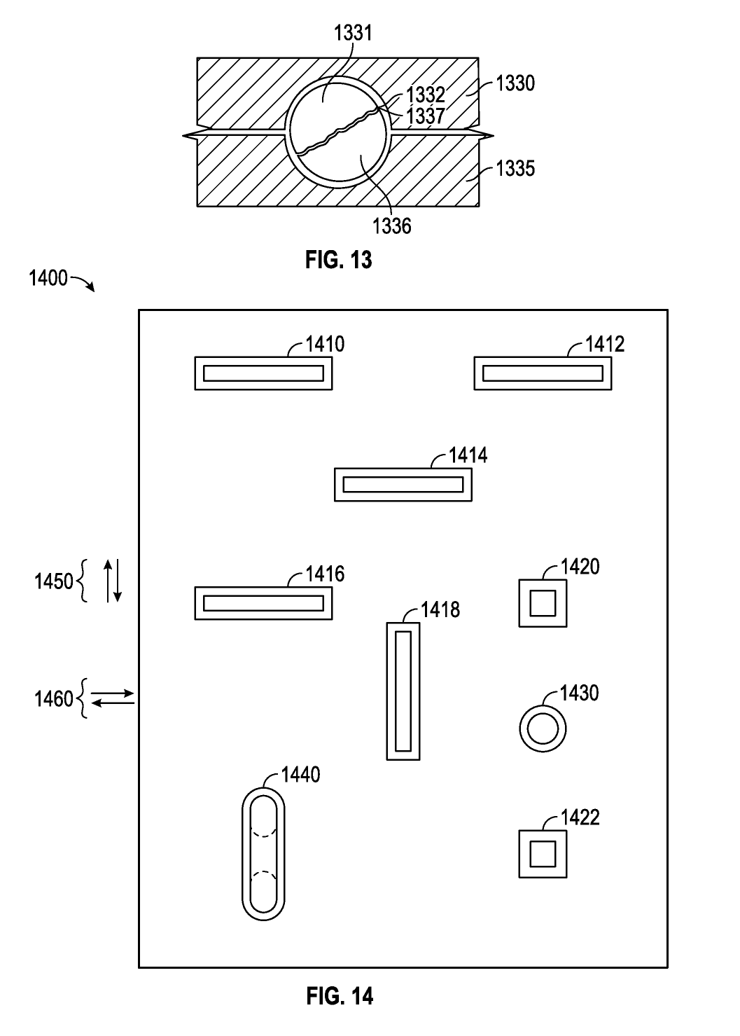

As mentioned above, processing circuit 1150 may selectively lock/unlock or engage/disengage object(s). However, the objects may include specific patterning that affects the interlocking or engagement. FIG. 13 depicts specific texturing for mating surfaces 1332, 1337 of movable members 1331, 1336. The texturing may be patterned such that only mating surfaces 1332 and 1337 are mateable. In other words, each movable member has a specific texturing and/or coating that is mateable with only one other movable member. In this regard, the texturing and/or coating of the movable members controls the orientation of the substrates for alignment and locking. For example, mating surface 1337 may define a cavity in movable member 1336 that is sized to receive a protrusion on mating surface 1332 of movable member 1331. If the protrusion on mating surface 1332 is aligned with another movable member (that does not have the specific cavity), the protrusion may push apart the two movable members and cause the objects to be disengaged. In this regard, only specific movable members of specific objects are engageable.

In another example, the placement (i.e., patterning) and type of movable members may be used to control which objects may be engaged. FIG. 14 depicts a top view of object 1400 according to one embodiment. Object 1400 includes half-cylinder shaped rotatable members 1410, 1412, 1414, 1416, and 1418. Object 1400 also includes rectangular prism shaped translatable members 1420 and 1422. Object 1400 further includes sphere shaped rotatable member 1430 and half-toroid shaped rotatable member 1440. Thus, object 1400 includes rotatable and translatable movable member types with varying shapes of each. Not only may the placement of each movable member be specific to one or more other objects, but the type, shape, and size of the movable member may add another layer of specificity to further limit the objects that may be locked with a specific object (e.g., object 1400). According to one embodiment, the movable members may be distributed in a random arrangement. In another embodiment, the movable members may be distributed in matching (first object to second object) periodical arrangements, such as in a square, rectangular, triangular, or hexagonal grid, or according to a pattern or formula. According to other embodiments, for non-circularly-symmetric recesses (i.e., non-spherical rotatable members/recesses), the recesses (and corresponding movable members) may be oriented uniformly in one direction, or in two or more directions, and for multiple orientations, the directions may be random, regular, or arranged according to a formula or pattern. For example, rotatable members 1410, 1412, 1414, and 1416 are oriented in the same direction relative to directions 1460. However, rotatable member 1418 is rotatable about a plane defined by arrows 1460. The rotation plane of rotatable member 1418 is substantially perpendicular to that of rotatable members 1410, 1412, 1414, and 1416. Accordingly, this configuration may be used to constrain translational movement of two engaged objects in two translational directions (e.g., in directions of arrows 1450 and 1460) relatively better than if rotatable member 1418 was not included with object 1400. This configuration is described above. In comparison, half-toroid rotatable member 1440 is oriented in a direction aligning with directions 1450. In some embodiments, the orientations may be the same for all movable members, the same for movable members of the same type (i.e., half-toroid rotatable members and half-cylinder rotatable members), and/or any type of orientation based on the application. The recess/movable member pattern may be correlated with a recess/movable member pattern to increase or to decrease the likelihood of matches (i.e., alignment of movable members), to tailor the density of such matches, to the number of matches as a function of contact position or motion (e.g., a substantial guarantee of 30 alignments/square distance; or to a substantial guarantee of 60 alignments/square distance with no more than a 0.5 distance slide or a 5 degree rotation). Furthermore, the patterning may be designed to increase or decrease matches (i.e., alignments) at given orientations (i.e., surfaces bind better at 30 degree relative orientation than at 90 degrees). Accordingly, magnets or other actuation force members (e.g., off-centered weights) may be strategically placed in or on the movable members to cause the matches to occur at a greater rate at some chosen orientations over other orientations.

The embodiments of FIGS. 13-14 illustrate structural configurations of the objects (FIG. 14) and mating surfaces (FIG. 13). These configurations may be customized, tailored, and otherwise designated to control compatibility of one or more objects for interlocking or engagement. FIGS. 11-12 illustrate how control system 1100 may interact with objects to lock/unlock or engage/disengage the objects. Referring further to FIG. 11, processing circuit 1150 is structured to receive position data from sensor 1130. Sensor 1130 may be communicably coupled to processing circuit 1150, actuator 1120, and one or more objects (e.g., object 1400). Sensor 1130 may include any type of sensor that acquires data relating to at least one of the position of, size of, and type of at least one of the movable member of an object. For example, sensor 1130 may include position determining sensors, such as via a coordinate measuring machine. Sensors 1130 may be coupled to actuator 1120 to monitor movement of first and second objects caused by actuator 1120.

Based on the position data, processing circuit 1150 may determine whether an alignment standard is met. If the alignment standard is met, processing circuit 1150 may provide a command to move the movable members to engage the objects. If the alignment standard is not met, processing circuit 1150 may provide a command to manipulate orientation of the objects relative to each other to meet the alignment standard. The alignment standard refers to one or more predefined alignment standards for at least one object and movable member. One alignment standard may be whether at least one recess of a first object is able to receive a movable member of a second object in order to engage the two objects. Another alignment standard may be whether at least one pair of movable members of a first and a second object are in a position to mate. While these minimum levels of alignment may be acceptable for some situations, other configurations may need a relatively more secure level of engagement. Some situations may even require that the objects be interlocked (see FIG. 7A). As an example, an alignment standard may require that a predetermined percentage of movable member pairs must be aligned (i.e., able to interact to engage the objects) relative to the total number of movable members for each object in order for the objects to be determined to be aligned (e.g., thirty-percent of the total number of movable member pairs must be aligned to be mated). In another example, the types of movable members must be matched and aligned (e.g., referring to FIG. 14, half-toroid rotatable member 1440 aligned a half-toroid rotatable member of another object). In other embodiments, the alignment standard is based on alignment of a preset threshold for each type of movable member in a plurality of movable members for the objects intended to be engaged. For example, there may be thirty half-cylinder rotatable member pairs and the threshold is fifty percent. If the position data indicates that sixteen half-cylinder rotatable member pairs are aligned, the alignment standard is met. In still another example, the shape of the objects themselves may define alignment. For example, each object may have the same type and placement of movable members such that alignment of the objects themselves also aligns the movable members. The alignment standard(s) may be predefined by I/O device 1110 and implemented by processing circuit 1150 using sensors 1130.

Based on the position data, processing circuit 1150 may determine that one or more movable members of one object are not aligned (i.e., not capable of mating with a movable member of and/or being received in a recess of another object). In which case, processing circuit 1150 may provide a command to actuate the unaligned movable members into the first range of positions to prevent the movable member(s) from disrupting the engagement between the objects.

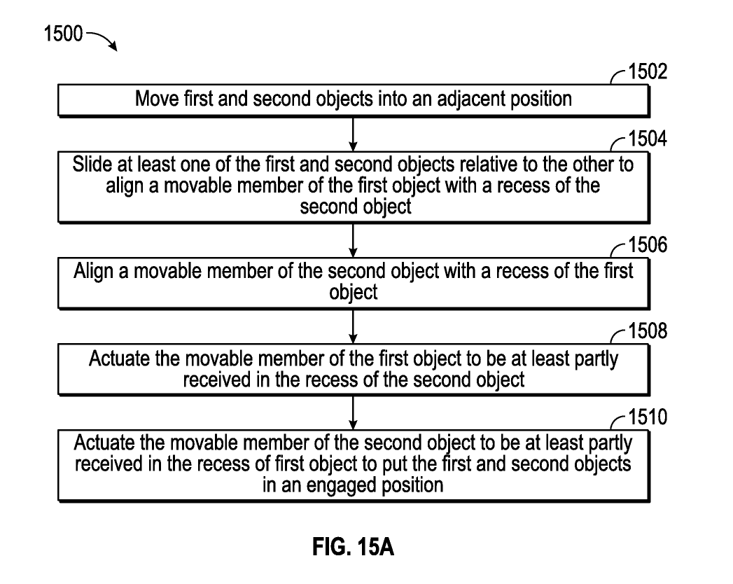

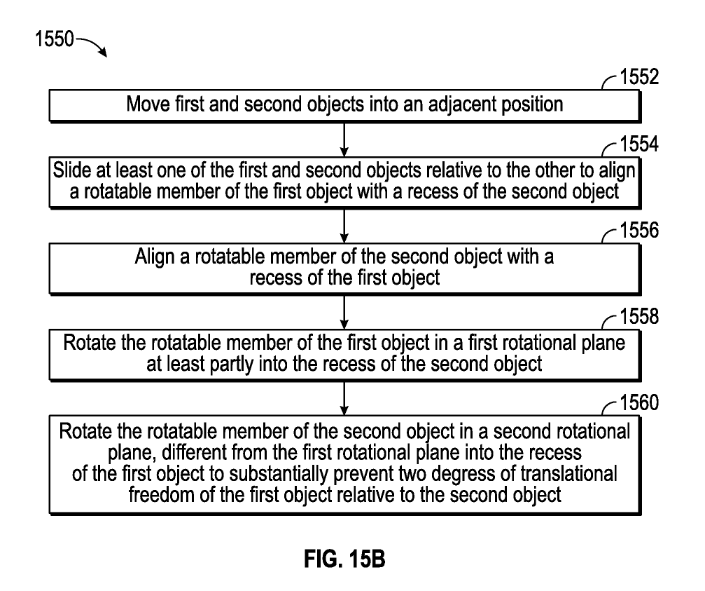

Referring now to FIG. 15A, method 1500 of engaging two or more objects is shown, according to one embodiment. Method 1500 may be utilized with the objects and components described herein in regard to FIGS. 1A-14.

At 1502, first and second objects are moved into an adjacent position. The adjacent position refers to a position where the objects are moved to prior to being engaged. This position may correspond with steps 301-302 of FIG. 3. In one embodiment, processing circuit 1150 may provide a command to actuator 1120 to move the first and second objects. At 1504, at least one of the first and second objects are slid relative to each other to align at least one movable member of the first objects with at least one recess of the second object. Accordingly, step 1504 may correspond with an alignment standard, as described above. At 1506, a movable member of the second object is aligned with a recess of the first object. In still other embodiments, alignment may be based on other alignment standards (e.g., a predetermined percentage of movable member pairs must be aligned relative to the total number of movable members for each object in order for the alignment standard to be met). This step may correspond with step 303 of FIG. 3.

At 1508, the movable member of the first object is actuated to be at least partly received in the aligned recess of the second object (i.e., into the second range of positions). The contact between the movable member of the first object and the surrounding recess of the second object may work to constrain translational movement of the two objects relative to each other. At 1510, the movable member of the second object is actuated to be at least partly received in the recess of the first object. The first object and second are in an engaged position, such that they restricted from translating (sliding) in at least one translational direction. In some embodiments, only step 1504 may be used with method 1500. When process 1506 is utilized, a relatively more secure engagement is achieved due to the multiple levels of engagement.

As described above, an actuation member may provide an actuation force to move the movable members. The actuation member may be located on the first and second objects and/or be an externally located actuation member (e.g., magnetic actuation device 1220). For example, a magnetic field generated via externally located magnetic actuation device 1220 may cause the rotatable members to rotate into the second range of positions and engage the first object to the second object. To disengage the first and second objects, re-actuation of magnetic actuation device 1220 may be commanded. At which point, the objects may be re-used for other applications. This step corresponds with step 304 of FIG. 3. There, the actuation force was provided by magnetic actuation members included with the object and movable members. In other embodiments, as mentioned above, an external actuation member may provide the actuation force (e.g., hydraulic fluid that moves the movable members may be supplied from a hydraulic pump).

While method 1500 is described in regard to first and second objects, it should be understood that more than one objects may be interlocked and/or engaged with one object. It should also be understood that the objects to be interlocked and/or engaged may include specific structures that prevent the object from locking or engaging with other objects. For example, the patterning of the movable members may only correspond with one other object. In another example, the patterning on one or more movable members may only correspond with the patterning on the movable members with one other object. As such, determining whether two or more objects are engageable may be included in step 1506.

Referring now to FIG. 15B, another method 1550 of engaging two or more objects is shown according to one embodiment. Method 1550 is substantially similar to method 1500 with a few noted differences. At 1552, first and second objects are moved into adjacent positions. At 1554, at least one of the first and second objects are slid relative to the other to align a first rotatable member of the first object with a first recess of the second object. At 1556, a first rotatable member of the second object is aligned with a first recess of the first object.

In addition to the use of rotatable members, method 1550 begins to substantially deviate from method 1500 at step 1558. At 1558, the first rotatable member of the first object is rotated in a first rotational plane at least partly into in the first recess of the second object. At 1560, the first rotatable member of the second object is rotated in a second rotational plane different from the first rotational plane into the first recess of the first object to substantially prevent two degrees of translational freedom of the first object relative to the second object. In one embodiment, the first and second rotational planes are substantially perpendicular to one another. In other embodiments, the rotational planes may be oriented in any position that substantially restricts translational movement of the first object relative to the second object in at least two translational degrees of freedom.

In this configuration and as described above, the interaction of the rotational member with an end of a recess that it is received in is not the sole sliding prevention mechanism in one translational direction. In other words, if the first rotational member of the first object is minimally received in the first recess of the second object, only a small translational prevention force may be generated (in a first direction) by the first rotatable member contacting an end of the first recess of the second object. However, by providing a first rotatable member of the second object that rotates in a different plane relative to the first rotatable member of the first object, the interaction between that rotatable member and the recess of the first object corresponds with a relatively greater amount of surface area when the objects are moved in the first direction. Thus, method 1550 may be utilized when minimum sliding movement between engaged objects in two translational directions is desired.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An object, comprising:
an engagement surface defining a recess extending into the object; and
a movable member received within the recess;
wherein the movable member is movable between a first range of positions and a second range of positions, wherein in the first range of positions the movable member is at or below the engagement surface, and wherein in the second range of positions, at least a part of the movable member is above the engagement surface.

2. (canceled)

3. The object of claim 1, further comprising an actuation member, wherein the actuation member provides an actuation force to the movable member to cause the movable member to move between the first range of positions and the second range of positions.

4. The object of claim 3, wherein the actuation member includes at least one of a magnet, an off-centered weight, and a spring.

5. (canceled)

6. The object of claim 1, wherein the recess has the same shape as the movable member.

7. The object of claim 1, wherein the recess has a different shape from the movable member.

8. (canceled)

9. The object of claim 1, wherein the movable member is held within the recess by at least one of a spring, a magnetization force, and an adhesive.

10. The object of claim 1, wherein the movable member is held within the recess by a protrusion from the object, wherein the movable member is free to rotate around the protrusion from the object.

11. The object of claim 10, wherein the protrusion has a form of a half-cylinder.

12. The object of claim 11, wherein the protrusion has a form of a half-cylinder having an axis of rotation in a plane coplanar with the engagement surface.

13. The object of claim 10, wherein the protrusion has a form of a half-sphere supported by a post, wherein the post extends from an inner surface of the recess towards the half-sphere.

14. The object of claim 13, wherein the half-sphere has its spherical center in a plane coplanar with the engagement surface.

15. The object of claim 1, wherein the movable member is shaped as a half-cylinder and the recess is shaped as a half-cylinder.

16. The object of claim 15, wherein the half-cylinder recess is axially longer than the half-cylinder movable member, such that the half-cylinder movable member is translatable in an axial direction.

17-20. (canceled)

21. An object, comprising:
a bottom surface;
a top engagement surface positioned opposite the bottom surface, wherein the top engagement surface defines a recess extending between the top engagement surface and the bottom surface; and
a rotatable member received within the recess;
wherein the rotatable member is rotatable between a first range of positions and a second range of positions, wherein in the first range of positions the rotatable member is at or below the top engagement surface, and wherein in the second range of positions at least a part of the rotatable member is above the top engagement surface.

22. The object of claim 21, wherein the top engagement surface and the bottom surface are at least one of planar, concave, and convex.

23. The object of claim 21, wherein a shape of the rotatable member includes at least one of a half-sphere, a half ovoid, and a half toroid.

24. The object of claim 21, wherein the rotatable member includes at least one of a beveled edge, a rounded edge, and a tapered edge.

25. The object of claim 21, further comprising an actuation member, wherein the actuation member provides an actuation force to the movable member to cause the movable member to move between the first range of positions and the second range of positions.

26. The object of claim 25, wherein the actuation member includes at least one of a magnet, an off-centered weight, and a spring.

27. The object of claim 26, wherein the at least one of the magnet and spring hold the rotatable member to the object.

28-29. (canceled)

30. The object of claim 21, wherein the recess has the same shape as the rotatable member.

31. The object of claim 21, wherein the recess has a different shape from the rotatable member.

32-35. (canceled)

36. The object of claim 21, wherein the rotatable member is rotatable about a pivot point coplanar with the top surface.

37. The object of claim 36, wherein the rotatable member is rotatable up to ninety-degrees relative to the pivot point.

38. The object of claim 21, wherein the top surface defines a groove in the recess and the rotatable member includes a protrusion structured to be received in the groove, wherein the groove extends to a depth closer to the bottom surface than the recess.

39. The object of claim 38, wherein a shape of the protrusion includes at least one of a cylinder, a rectangular prism, a cube, a triangular prism, and a hexagonal prism.

40. The object of claim 38, wherein a shape of the groove is the same as a shape of the protrusion.

41. The object of claim 38, wherein a shape of the groove is different from a shape of the protrusion.

42. The object of claim 38, wherein interaction between the protrusion and the groove define a range of rotation of the rotatable member.

43-59. (canceled)

60. An object, comprising:
an engagement surface defining a recess extending into the object; and
a translatable member received within the recess;
wherein the translatable member is translatable between a first range of positions and a second range of positions, wherein in the first range of positions the translatable member is at or below the engagement surface, and wherein in the second range of positions at least a part of the translatable member is above the engagement surface.

61. The object of claim 60, wherein the translatable member is held to the engagement surface by at least one of a spring and an expandable and collapsible shaft.

62. The object of claim 61, wherein the spring is structured to cause the translatable member to translate between the first range of positions and the second range of positions.

63. The object of claim 60, wherein a shape of the translatable member includes at least one of a cylinder, a rectangular prism, a hexagonal prism, and a cube.

64-65. (canceled)

66. The object of claim 60, wherein the recess has the same shape as the translatable member.

67. The object of claim 60, wherein the recess has a different shape from the translatable member.

68-128. (canceled)
